(19) United States
(12) Patent Application Publication
(10) Pub. No.: US 2012/0176291 A1
(43) Pub. Date: Jul. 12, 2012

(54) INPUT DEVICE FOR COMPUTER SYSTEM

(75) Inventor: Tsung-Wen Hsueh, Taipei (TW)

(73) Assignee: PRIMAX ELECTRONICS LTD., Taipei (TW)

(21) Appl. No.: 13/045,355

(22) Filed: Mar. 10, 2011

(30) Foreign Application Priority Data
Jan. 7, 2011 (TW) 100100589

(51) Int. Cl. H01Q 5/00; H01Q 1/38; H01Q 9/00

(52) U.S. Cl. 343/843; 343/700 MS

(57) ABSTRACT

A planar dual-band antenna is provided. The planar dual-band antenna is G-shaped, and includes a first radiating part and a second radiating part. The first radiating part includes a first vertical radiating strip, a first horizontal radiating strip, a second vertical radiating strip and a second horizontal radiating strip. The second radiating part includes a third horizontal radiating strip, a third vertical radiating strip and a fourth horizontal radiating strip. The first vertical radiating strip has a connecting node. A first end of the first vertical radiating strip is served as a feeding point of the planar dual-band antenna. The second radiating part is connected with the connecting node of the first vertical radiating strip. In such way, two current paths of the planar dual-band antenna are defined.

### FIELD OF THE INVENTION

The present invention relates to an antenna, and more particularly to a monopole antenna that operates at two frequency bands.

### BACKGROUND OF THE INVENTION

In recent years, the development of the wireless communication industry is vigorous. The wireless communication devices have become indispensable commodities and can be widely used in diversified places (e.g. homes, schools, offices, and the like).

The standards for wireless communication protocols include an IEEE 802.11a standard and an IEEE 802.11b/g standard. The IEEE 802.11a standard covers the working frequency band at 5.15˜5.875 GHz. The IEEE 802.11b/g standard covers the working frequency band at 2.4˜2.5 GHz. For allowing a wireless communication product to comply with both of the IEEE 802.11a standard and the IEEE 802.11b/g standard, the wireless communication product is usually equipped with a dual-band or multi-band antenna. For example, as shown in FIG. 1, a planar dual-band antenna is disclosed in for example Chinese Patent Publication No. 2600925. As shown in FIG. 1, the radiating part 11, the first connecting part 12, the grounding part 10 and the feed line 13 of the planar dual-band antenna 1 collectively define a planar inverted-F antenna for transmitting or receiving signals at a low frequency band. The radiating part 11 comprises plural radiating slices 111˜118, which are connected with each other. The inner-core wire 14, the radiating slice 111, the radiating slice 112, the radiating slice 113, the radiating slice 114, the second connecting part 15, the grounding part 10 and the metallic mesh layer 16 of the planar dual-band antenna 1 collectively define a circular antenna for transmitting or receiving signals at a high frequency band. By integrating two different antenna forms, the working frequency band of the dual-frequency antenna 1 is widened to cover the working frequency band of the IEEE 802.11a standard and the IEEE 802.11b/g standard.

It is found that the conventional dual-frequency antenna is complicated and bulky. As known, the bandwidth, the gain value and the radiating efficiency of the antenna are in direct proportion to the volume of the antenna. If the volume of the antenna of the wireless communication produced is reduced, the bandwidth of the working frequency band of the dual-frequency antenna fails to simultaneously cover the working frequency bands of the IEEE 802.11a standard and the IEEE 802.11b/g standard. In other words, the conventional dual-frequency antenna is detrimental to miniaturization of the electronic product. Therefore, there is a need of providing a small-sized planar dual-band antenna.

### SUMMARY OF THE INVENTION

It is an object of present invention to provide a small-sized planar dual-band antenna.

In accordance with an aspect of the present invention, there is provided a planar dual-band antenna. The planar dual-band antenna includes a first radiating part and a second radiating part. The first radiating part has a start terminal and a final terminal, and includes a first vertical radiating strip, a first horizontal radiating strip, a second vertical radiating strip and a second horizontal radiating strip. The first vertical radiating strip has a connecting node. A first end of the first vertical radiating strip is defined as the start terminal. The start terminal is served as a feeding point of the planar dual-band antenna. The first horizontal radiating strip vertically extended from a second end of the first vertical radiating strip. The second vertical radiating strip is vertically extended from an end of the first horizontal radiating strip. The second horizontal radiating strip is extended from an end of the second vertical radiating strip and toward the first vertical radiating strip, and perpendicular to the second vertical radiating strip. The end of the second horizontal radiating strip that is closer to the first vertical radiating strip is defined as the final terminal. The second radiating part is connected to the connecting node of the first vertical radiating strip, and includes a third horizontal radiating strip, a third vertical radiating strip and a fourth horizontal radiating strip. The third horizontal radiating strip is extended from the connecting node and perpendicular to the first vertical radiating strip. The third vertical radiating strip is extended from an end of the third horizontal radiating strip and toward the first horizontal radiating strip, and perpendicular to the third horizontal radiating strip. The fourth horizontal radiating strip is extended from an end of the third vertical radiating strip and toward the first vertical radiating strip, and perpendicular to the third vertical radiating strip.

In an embodiment, the planar dual-band antenna further includes a substrate. The first radiating part and the second radiating part are mounted on the substrate. The substrate is made of fiberglass reinforced epoxy resin (FR4).

In an embodiment, the start terminal, the first vertical radiating strip, the first horizontal radiating strip, the second vertical radiating strip and the second horizontal radiating strip collectively define a first current path for transmitting or receiving signals at a first working frequency band. The first working frequency band is a low frequency band. The path length of the first current path is nearly one-fourth of a wavelength of the first working frequency band.

In an embodiment, the start terminal, the connecting node, the third horizontal radiating strip, the third vertical radiating strip and the fourth horizontal radiating strip collectively define a second current path for transmitting or receiving signals at a second working frequency band. The second working frequency band is a high frequency band. The path length of the second current path is nearly one-fourth of a wavelength of the second working frequency band.

In an embodiment, the widths of the first vertical radiating strip, the first horizontal radiating strip, the second vertical radiating strip, the second horizontal radiating strip, the third horizontal radiating strip, the third vertical radiating strip and the fourth horizontal radiating strip are identical and in the range between 1.2 mm and 1.8 mm.

In an embodiment, the distance between the third vertical radiating strip and the first horizontal radiating strip is in the range between 0.7 mm and 1.3 mm.

In an embodiment, the distance between the final terminal and the third vertical radiating strip is in the range between 0.7 mm and 1.3 mm.

In an embodiment, the length of the first vertical radiating strip is in the range between 12.6 mm and 11.4 mm.

In an embodiment, the length of the first horizontal radiating strip is in the range between 10.6 mm and 9.4 mm.

In an embodiment, the length of the second vertical radiating strip is in the range between 6.8 mm and 5.6 mm.

In an embodiment, the length of the second horizontal radiating strip is in the range between 3.6 mm and 2.4 mm.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a conventional planar dual-band antenna;

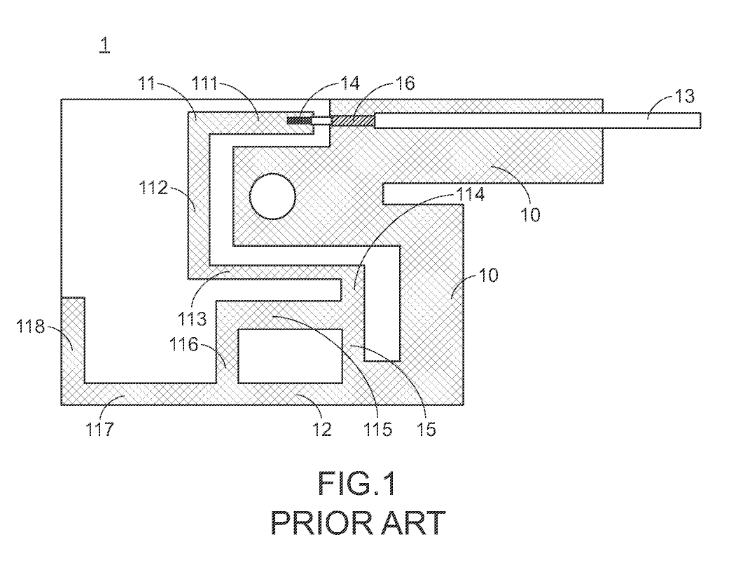

FIG. 2 is a schematic view illustrating a planar dual-band antenna according to an embodiment of the present invention;

FIG. 3 is a schematic view illustrating a current path of the planar dual-band antenna of FIG. 2; and

FIG. 4 is a plot illustrating the relationship between the return loss and the frequency of the planar dual-band antenna of the present invention according to actual measurement.

### DETAILED DESCRIPTION OF THE PREFERRED EMBODIMENT

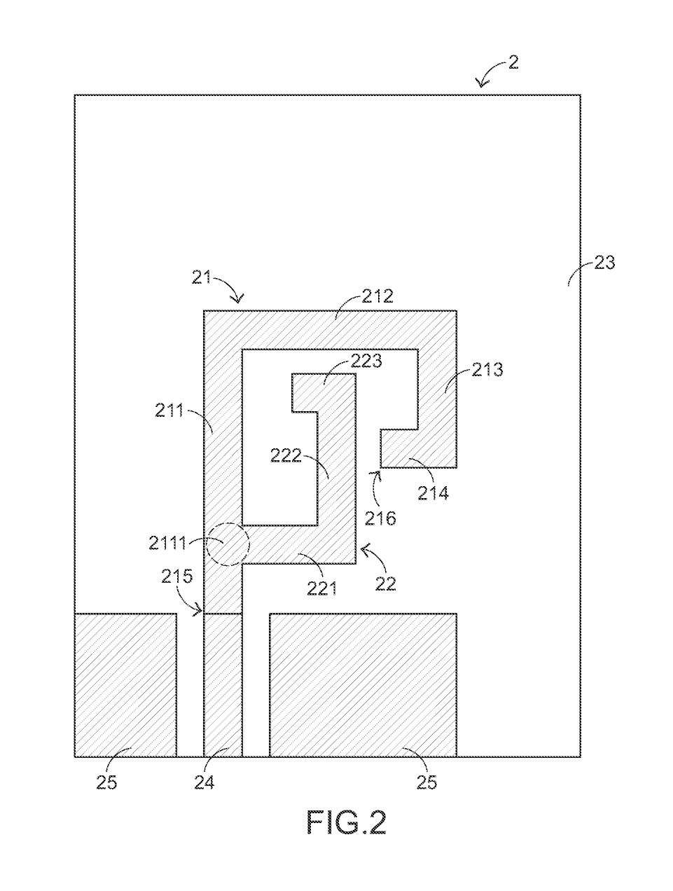

FIG. 2 is a schematic view illustrating a planar dual-band antenna according to an embodiment of the present invention. As shown in FIG. 2, the planar dual-band antenna 2 comprises a first radiating part 21 and a second radiating part 22. The first radiating part 21 and the second radiating part 22 are metallic strips, which are connected with each other and mounted on a substrate 23. In this embodiment, the substrate 23 is made of fiberglass reinforced epoxy resin (FR4).

Please refer to FIG. 2 again. The first radiating part 21 comprises a first vertical radiating strip 211, a first horizontal radiating strip 212, a second vertical radiating strip 213 and a second horizontal radiating strip 214. The first vertical radiating strip 211 has a connecting node 2111. Via the connecting node 2111, the first vertical radiating strip 211 is connected with the second radiating part 22. A first end of the first vertical radiating strip 211 is defined as a start terminal 215 of the first radiating part 21. The start terminal 215 is the feeding point of the planar dual-band antenna 2. A second end of the first vertical radiating strip 211 is connected with the first horizontal radiating strip 212. The first horizontal radiating strip 212 is vertically extended from the second end of the first vertical radiating strip 211. The second vertical radiating strip 213 is vertically extended from an end of the first horizontal radiating strip 212. The second horizontal radiating strip 214 is vertically extended from an end of the second vertical radiating strip 213 and toward the first vertical radiating strip 211. The end of the second horizontal radiating strip 214 that is closer to the first vertical radiating strip 211 is defined as a final terminal 216 of the first radiating part 21. The second radiating part 22 comprises a third horizontal radiating strip 221, a third vertical radiating strip 222 and a fourth horizontal radiating strip 223. The third horizontal radiating strip 221 is extended from the connecting node 2111 of the first vertical radiating strip 211, and perpendicular to the first vertical radiating strip 211. The third vertical radiating strip 222 is vertically extended from an end of the third horizontal radiating strip 221 and toward the first horizontal radiating strip 212. The fourth horizontal radiating strip 223 is vertically extended from an end of the third vertical radiating strip 222 and toward the first vertical radiating strip 211. Moreover, the start terminal 215 is connected with a feeding part 24. The feeding part 24 is an elongated strip. In addition, two grounding parts 25 are respectively arranged at bilateral sides of the feeding part 24.

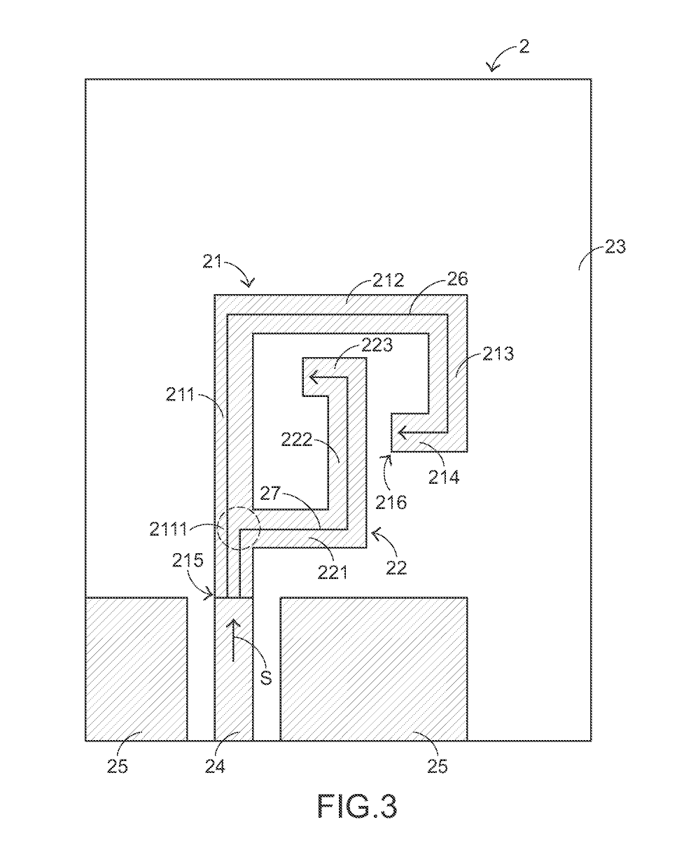

FIG. 3 is a schematic view illustrating a current path of the planar dual-band antenna of FIG. 2. Please refer to FIGS. 2 and 3. The path from the start terminal 215 to the final terminal 216 through the first vertical radiating strip 211, the first horizontal radiating strip 212, the second vertical radiating strip 213 and the second horizontal radiating strip 214 is defined as a first current path 26. A signal S is fed into the first current path 26 through the start terminal 215 to trigger the first current path 26, so that the planar dual-band antenna 2 can be operated at a first working frequency band. The path from the start terminal 215 to the fourth horizontal radiating strip 223 through the connecting node 2111, the third horizontal radiating strip 221 and the third vertical radiating strip 222 is defined as a second current path 27. The signal S is fed into the second current path 27 through the start terminal 215 to trigger the second current path 27, so that the planar dual-band antenna 2 can be operated at a second working frequency band. As shown in FIG. 3, the first current path 26 is longer than the second current path 27. As a consequence, the first working frequency band is a low frequency band, and the second working frequency band is a high frequency band.

In this embodiment, the planar dual-band antenna 2 is a monopole antenna. By using the image effect resulted from the grounding parts 25, the current distribution of the monopole antenna is similar to that of the dipole antenna while the length of the monopole antenna is only one half of the dipole antenna. Since the length of the dipole antenna is one half of the wavelength of the working frequency band, the path length of the first current path 26 of the planar dual-band antenna 2 is nearly one-fourth of the wavelength of the first working frequency band, and the path length of the second current path 27 of the planar dual-band antenna 2 is nearly one-fourth of the wavelength of the second working frequency band.

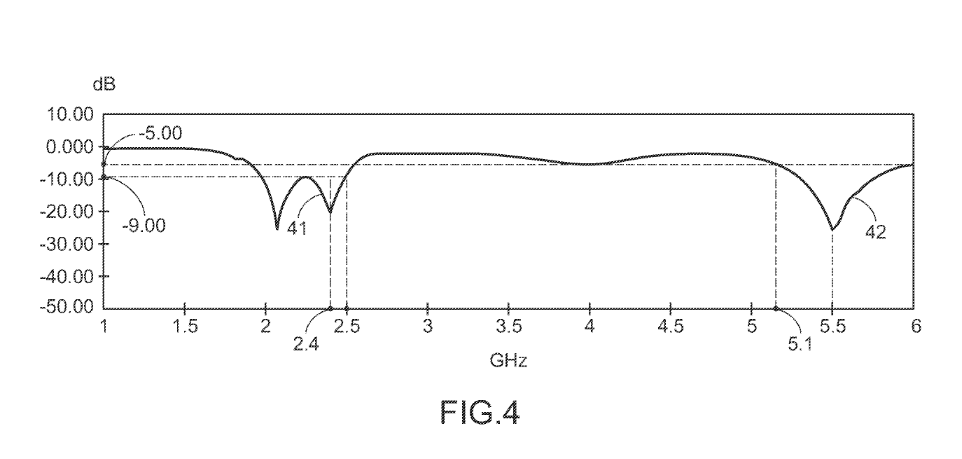

FIG. 4 is a plot illustrating the relationship between the return loss and the frequency of the planar dual-band antenna of the present invention according to actual measurement. The horizontal axis indicates the working frequency (GHz) of the planar dual-band antenna 2. The vertical axis indicates the return loss (dB) of the planar dual-band antenna 2. Please refer to FIG. 2. The parameters used in the actual measurement of the planar dual-band antenna 2 will be illustrated as follows. The length of the first vertical radiating strip 211 is 12 mm. The length of the first horizontal radiating strip 212 is 10 mm. The length of the second vertical radiating strip 213 is 6.2 mm. The length of the second horizontal radiating strip 214 is 3 mm. The widths of the horizontal radiating strips and the vertical radiating strips are all 1.5 mm. The distance between the third vertical radiating strip 222 and the first horizontal radiating strip 212 is 1 mm. The distance between the final terminal 216 and the third vertical radiating strip 222 is 1 mm.

The results of the planar dual-band antenna 2 according to actual measurement will be illustrated as follows. The planar dual-band antenna 2 can transmit or receive signals at the first working frequency band 41 (on the basis of 9 dB return loss) and also transmit or receive signals at the second working frequency band 42 (on the basis of 5 dB return loss). The first working frequency band 41 covers the frequency band at 2.4˜2.5 GHz with a peak value of 2.4 GHz. The second working frequency band 42 covers the frequency band at 5.1˜6 GHz with a peak value of 5.5 GHz. The bandwidth of the first working frequency band 41 is 100 MHz. The bandwidth of the second working frequency band 42 is 900 MHz. As a consequence, the planar dual-band antenna 2 of the present invention can comply with the IEEE 802.11a standard and the IEEE 802.11b/g standard of the wireless local area network system to be operated at the working frequency band covering 2.4˜2.5 GHz and 5.15˜5.875 GHz. Moreover, by electromagnetic software ID3E, the simulating results shows that the peak gain values of the planar dual-band antenna 2 are 0.5 dBi and 2 dBi for the first working frequency band 41 and the second working frequency band 42.

In practice, by fine-tuning the above parameters, the applications of the planar dual-band antenna 2 may be expanded to achieve similar function of transmitting or receiving signals. For example, the width of each of the first vertical radiating strip 211, the first horizontal radiating strip 212, the second vertical radiating strip 213, the second horizontal radiating strip 214, the third horizontal radiating strip 221, the third vertical radiating strip 222 and the fourth horizontal radiating strip 223 is in the range between 1.2 mm and 1.8 mm. The distance between the third vertical radiating strip 222 and the first horizontal radiating strip 212 is in the range between 0.7 mm and 1.3 mm. The distance between the final terminal 216 and the third vertical radiating strip 222 is in the range between 0.7 mm and 1.3 mm. The length of the first vertical radiating strip 211 is in the range between 12.6 mm and 11.4 mm. The length of the first horizontal radiating strip 212 is in the range between 10.6 mm and 9.4 mm. The length of the second vertical radiating strip 213 is in the range between 6.8 mm and 5.6 mm. The length of the second horizontal radiating strip 214 is in the range between 3.6 mm and 2.4 mm.

From the above description, the planar dual-band antenna 2 of the present invention uses the first radiating part 21 and the second radiating part 22 to form the first current path 26 and the second current path 27 to transmit or receive electromagnetic wave signals at the working frequency band covering 2.4˜2.5 GHz and 5.15˜5.875 GHz. In other words, the planar dual-band antenna 2 of the present invention can be operated at the electromagnetic wave frequency band complying with the IEEE 802.11a standard and the IEEE 802.11b/g standard. Moreover, the planar dual-band antenna 2 has a simplified structure and can save the layout space.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A planar dual-band antenna, comprising:
a first radiating part having a start terminal and a final terminal, and comprising:
a first vertical radiating strip having a connecting node, wherein a first end of said first vertical radiating strip is defined as said start terminal, and said start terminal is served as a feeding point of said planar dual-band antenna;
a first horizontal radiating strip vertically extended from a second end of said first vertical radiating strip;
a second vertical radiating strip vertically extended from an end of said first horizontal radiating strip; and
a second horizontal radiating strip extended from an end of said second vertical radiating strip and toward the first vertical radiating strip, and perpendicular to said second vertical radiating strip, wherein said end of said second horizontal radiating strip that is closer to said first vertical radiating strip is defined as said final terminal; and
a second radiating part connected to said connecting node of said first vertical radiating strip, and comprising:
a third horizontal radiating strip extended from said connecting node and perpendicular to said first vertical radiating strip;
a third vertical radiating strip extended from an end of said third horizontal radiating strip and toward said first horizontal radiating strip, and perpendicular to said third horizontal radiating strip; and
a fourth horizontal radiating strip extended from an end of said third vertical radiating strip and toward the first vertical radiating strip, and perpendicular to said third vertical radiating strip.

2. The planar dual-band antenna according to claim 1 further comprising a substrate, wherein said first radiating part and said second radiating part are mounted on said substrate, and said substrate is made of fiberglass reinforced epoxy resin (FR4).

3. The planar dual-band antenna according to claim 1 wherein said start terminal, said first vertical radiating strip, said first horizontal radiating strip, said second vertical radiating strip and said second horizontal radiating strip collectively define a first current path for transmitting or receiving signals at a first working frequency band, wherein said first working frequency band is a low frequency band, and the path length of said first current path is nearly one-fourth of a wavelength of said first working frequency band.

4. The planar dual-band antenna according to claim 1 wherein said start terminal, said connecting node, said third horizontal radiating strip, said third vertical radiating strip and said fourth horizontal radiating strip collectively define a second current path for transmitting or receiving signals at a second working frequency band, wherein said second working frequency band is a high frequency band, and the path length of said second current path is nearly one-fourth of a wavelength of said second working frequency band.

5. The planar dual-band antenna according to claim 1 wherein the widths of said first vertical radiating strip, said first horizontal radiating strip, said second vertical radiating strip, said second horizontal radiating strip, said third horizontal radiating strip, said third vertical radiating strip and said fourth horizontal radiating strip are identical and in the range between 1.2 mm and 1.8 mm.

6. The planar dual-band antenna according to claim 1 wherein the distance between said third vertical radiating strip and said first horizontal radiating strip is in the range between 0.7 mm and 1.3 mm.

7. The planar dual-band antenna according to claim 1 wherein the distance between said final terminal and said third vertical radiating strip is in the range between 0.7 mm and 1.3 mm.

8. The planar dual-band antenna according to claim 1 wherein the length of said first vertical radiating strip is in the range between 12.6 mm and 11.4 mm.

9. The planar dual-band antenna according to claim 1 wherein the length of said first horizontal radiating strip is in the range between 10.6 mm and 9.4 mm.

10. The planar dual-band antenna according to claim 1 wherein the length of said second vertical radiating strip is in the range between 6.8 mm and 5.6 mm.

11. The planar dual-band antenna according to claim 1 wherein the length of said second horizontal radiating strip is in the range between 3.6 mm and 2.4 mm.
